(19) United States
(12) Patent Application Publication
(10) Pub. No.: US 2014/0108401 A1
(43) Pub. Date: Apr. 17, 2014

(54) System and Method for Adjusting Distributions of Data Using Mixed Integer Programming

(71) Applicant: Opera Solutions, LLC, Jersey City, NJ (US)

(72) Inventors: Mahdi Namazifar, San Diego, CA (US); Mohammad H. Taghavi Nasrabadi, San Diego, CA (US)

(73) Assignee: Opera Solutions, LLC, Jersey City, NJ (US)

(21) Appl. No.: 14/046,232

(22) Filed: Oct. 4, 2013

Related U.S. Application Data
(60) Provisional application No. 61/710,120, filed on Oct. 5, 2012.

(51) Int. Cl. G06F 17/30

(52) U.S. Cl. CPC G06F 17/30312
USPC 707/736

(57) ABSTRACT

Exemplary embodiments of the present disclosure are related to systems, methods, and computer-readable medium to facilitate modifying a distribution of data elements to more closely resemble a reference distribution. In exemplary embodiments a modification constraint can be assigned to limit a modification of data elements in a subject distribution and a reference distribution can be identified. Data elements in the subject distribution can be programmatically modified to generate a modified distribution based on a reference distribution, wherein a modification of the data elements can be constrained in response to the modification constraint.

### RELATED APPLICATIONS

This application claims the priority of U.S. Provisional Application Ser. No. 61/710,120 filed Oct. 5, 2012, the entire disclosure of which is expressly incorporated herein by reference.

### BACKGROUND OF THE INVENTION

1. Field of the Invention

The present invention relates generally to a system and method for adjusting a distribution of data to more closely resemble a reference distribution. More specifically, the present invention relates to a system and method for adjusting distributions of data elements to more closely resemble a specified reference histogram distribution, using mixed integer programming.

2. Related Art

In many applications, it can be useful to process data having a particular distribution to more closely resemble a specified reference distribution. For example, in image processing, histogram modification techniques such as histogram equalization and histogram matching (specification) are commonly used for adjusting the contrast, color, and other characteristics of an image. In histogram matching for a gray image, a transformation function can be implemented to process the grayscale values of the image pixels so that the histogram of the adjusted values matches the histogram of the grayscale values of the reference image.

Histograms can also be modified to enhance the performance of sub-optimal regression techniques. In many cases, not only is the correct rank-ordering of the observations important, but making an accurate prediction of the target values may also be important. For instance, the objective for an application may be to predict the probability of an event for each observation, and that predicted probability may be later used to compute an expected value. In such cases, if the original regression technique produces an acceptable rank-ordering of the observations, an adjustment of the predictions may improve the performance. Towards this goal, when the distribution of the target value is approximately known, the distribution of the predictions can be adjusted based on the known reference distribution so that errors associated with the predictions can be reduced. Modification of a distribution can be implemented in a pre-processing training step by, for example, adding a penalty to an objective function due to the mismatch between the corresponding distributions. Alternatively, distributions, e.g., histograms of predictions, can be modified in a post-processing step.

### SUMMARY OF THE INVENTION

Exemplary embodiments of the present disclosure are related to systems, methods, and computer-readable medium to facilitate modifying a distribution of data elements to more closely resemble a reference distribution. In exemplary embodiments a modification constraint can be assigned to limit a modification of data elements in a subject distribution and a reference distribution can be identified. Data elements in the subject distribution can be programmatically modified to generate a modified distribution based on a reference distribution, wherein a modification of the data elements can be constrained in response to the modification constraint.

An adjustment of a distribution associated with a set of data elements to more closely resemble a specified reference distribution can be performed using mixed integer programming. Exemplary embodiments of the present disclosure can include a distribution adjustment engine programmed and/or configured to implement a distribution adjustment process. The distribution adjustment process can apply one or more constraints to the modification of the data elements to minimize the dissimilarity between a distribution of the data elements in the data set and a reference distribution and/or to minimize the extent to which the data elements are modified.

In some embodiments, the modification constraint can a maximum offset that can be applied to the data elements and/or a maximum dissimilarity between the modified distribution and the reference distribution.

In some embodiments, at least one of the data elements can be modified by solving a mixed-integer linear program to minimize an offset applied to the at least one data element and minimize a dissimilarity between the subject distribution and the reference distribution.

In some embodiments, the subject distribution, modified distribution, and/or reference distribution can be histograms having bins to which the data elements are assigned. The modification constraint can prohibit assigning the data elements to more than one of the bins subsequent to modification of the data elements. Offsets can be applied to the data elements to modify a data values of the data elements to be center values of the bins. In some embodiments, the offsets can be applied to modify the data value of the at least one of the data elements so that the data element remains in an originally assigned bin and/or so that the data value corresponds to the center value of a different bin than an original bin to which the data element was assigned. In some embodiments, the offsets can be applied to the data elements, wherein the offsets are a convex combinations of two consecutive bin edges.

In some embodiments, the modification constraint can be a dissimilarity measure between the modified distribution and the reference distribution. The dissimilarity measure can be defined on a bin-by-bin basis by comparing corresponding pairs of bins of the subject distribution and the reference distribution, can be determined utilizing a Minkowski distance, can be determined utilizing a scaled distance measure, and/or can be determined utilizing a Kullback-Leibler Divergence dissimilarity measure.

### BRIEF DESCRIPTION OF THE DRAWINGS

The foregoing features of the invention will be apparent from the following Detailed Description of the Invention, taken in connection with the accompanying drawings, in which:

FIG. 1 is a block diagram of an exemplary distribution adjustment engine of the present disclosure;

FIG. 2 is a flowchart showing overall processing steps carried out by an exemplary an exemplary embodiment of the distribution adjustment engine;

FIG. 3 is a flowchart showing processing steps for modifying a data set to adjust a distribution of the data set;

FIG. 4 is an example graph showing a linear approximation of a log function.

FIG. 5 is a diagram showing hardware and software components of an exemplary system of the present disclosure;

FIGS. 6-13 are graphs showing experimental results of applying exemplary embodiments of the present disclosure to a healthcare environment; and

FIGS. 14-18 are graphs showing experimental results of applying exemplary embodiments of the present disclosure to a financial environment.

### DETAILED DESCRIPTION OF THE INVENTION

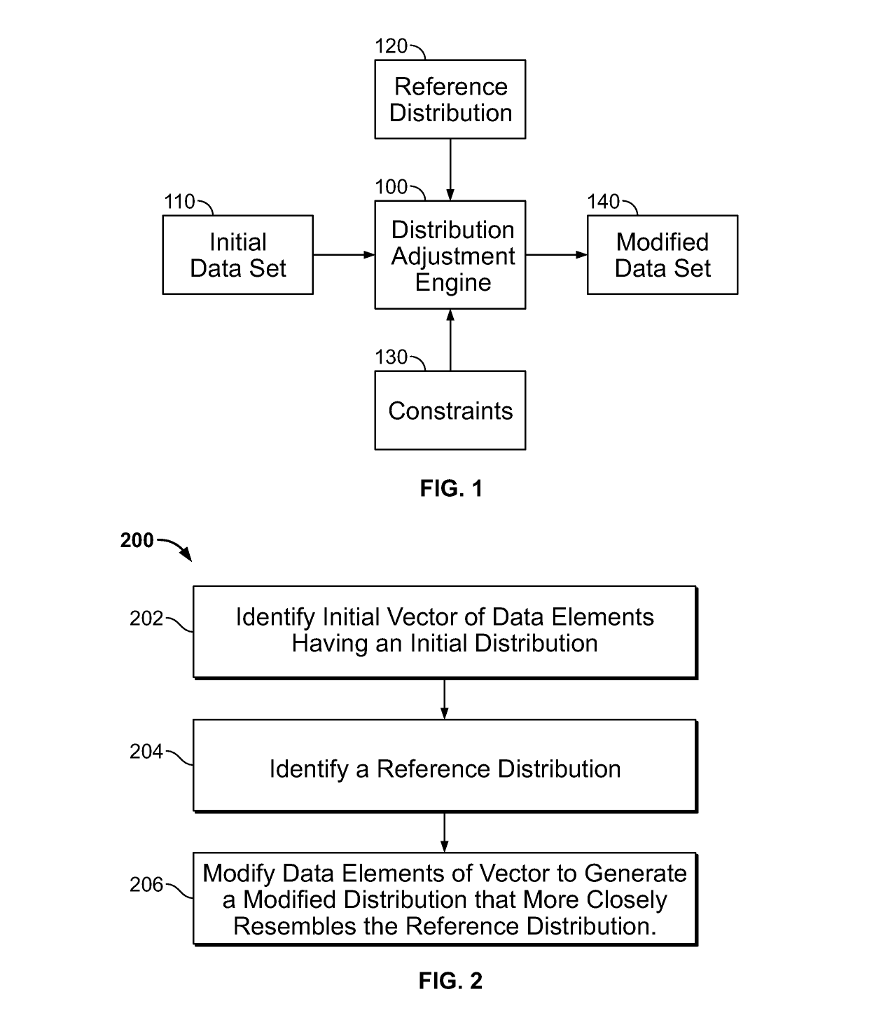

The present invention relates to a system and method for adjusting a distribution associated with a set of data elements to be more similar to a specified reference or target distribution, as discussed in detail below in connection with FIGS. 1-18. The terms “reference distribution” and “target distribution” are used interchangeably herein. The system and method can use mixed-integer programming to modify data elements in a data set while minimizing the dissimilarity between a distribution of the data elements in the data set and a reference distribution and/or while minimizing the extent to which the data elements are modified.

Exemplary embodiments are provided for pre- and/or post-processing of data elements using one or more constraints programmed and/or configured to optimize the modification of the data elements. As one example, in an exemplary embodiment, data elements of a data set to be modified can correspond to predictions and/or probabilities, the distribution of which can be represented as a histogram, and the data elements can be modified so that the histogram more closely resembles a reference histogram associated with preexisting data elements. As another example, in an exemplary embodiment, data elements of a data set to be modified can correspond to obtained, measured, and/or observed data elements, the distribution of which can be represented as a histogram, and the data elements can be modified so that the histogram more closely resembles a histogram associated with a generic reference distribution. In some embodiments, the adjustment of a distribution according to exemplary embodiments of the present disclosure can be implemented as a post-processing step in a regression problem.

By using different measures for the distribution dissimilarity and modification in data, and modifying the way the data elements are adjusted, exemplary embodiments advantageously provide a flexible and efficient approach to distribution adjustment. Exemplary embodiments set forth a number of techniques to improve the efficiency of solving the optimization for distribution adjustments which advantageously introduce constraints that shrink the feasible space but are still valid. Exemplary embodiments of the present disclosure can be implemented for various data processing problems for which distribution adjustment is applicable. In some embodiments, techniques such as histogram matching and equalization can be implemented in conjunction with distribution adjustment processes described herein.

FIG. 1 is a block diagram of an exemplary embodiment of a distribution adjustment engine 100 in accordance with the present system programmed and/or configured to implement a distribution adjustment process. The engine 100 can be implemented to modify data elements included in a data set or vector so that the distribution of the data elements in the data set more closely resembles a reference distribution. Implementations of exemplary embodiments of the distribution adjustment engine 100 can be applied to various applications for which it is desirable, optimal, appropriate, and/or suitable to adjust a distribution of a data set to more closely resemble a reference distribution. As one non-limiting example, the engine 100 can be implemented as a portion of an image processing system to process image data captured by an imaging device to adjust pixel data to more closely resemble a specified distribution to adjust for brightness contrast, color, and/or any other suitable parameter in image data. As another non-limiting example, the engine 100 can be implemented in a healthcare environment to improve predictions related to prospective health or patient trends, resource requirements (e.g., staffing, facilities, equipment), and/or any other suitable aspects or parameters associated therewith. As another non-limiting example, the engine 100 can be implemented in a financial environment to improve predictions related to risks of default by customers, likelihood of collecting on past due accounts, and/or any other suitable financial applications in which distribution adjustment may improve the accuracy of a predictive model.

The engine 100 can be programmed and/or coded to receive an initial vector 110 of data elements, a reference distribution 120, and one or more constraints 130, and can be programmed and/or configured to output a modified vector or data set 140 having a modified distribution that more closely resembles that reference distribution than the initial distribution of the vector 110. The data elements of the initial data set can correspond to obtained, collected, measured, observed, predicted, and/or probabilistic data having an initial distribution. In exemplary embodiments, the initial distribution can be represented as a histogram having bins, where each data element in the vector 110 is associated with one of the bins of the histogram, and the reference distribution can be represented a histogram.

The one or more constraints 130 can restrict parameters associated with the modification of the data elements of the initial vector 110. As one example, in an exemplary embodiment, one or more of the constraints 130 can include a modification parameter that provides an upper bound on an amount of modification that can be applied to the data elements of the initial vector 110 to configure and/or program the engine 100 to limit the extent to which the engine 100 modifies the data elements in the vector 110 when adjusting the distribution of the data elements. By setting an upper bound on the amount of modification that can be applied by the engine 100, the adjustment to the distribution of the data set vector 110 can be limited. As another example, in an exemplary embodiment, one or more of the constraints 130 can include a dissimilarity parameter that provides an upper bound on a dissimilarity between the modified distribution and the reference distribution to configure and/or program the engine 100 to limit the dissimilarity between the modified distribution and the reference distribution. In some embodiments, the constraints 130 can be specified by the user of the engine 100. In some embodiments, the constraints 130 can be specified by and/or integrated with the engine 100. The engine 100 can be programmed and/or configured to optimize adjustment of the initial distribution within the bounds of the constraints 130. For example, the engine 100 can be programmed and/configured to minimize the extent to which the data elements of the initial data set are modified and/or to minimize a dissimilarity between the modified distribution and the reference distribution.

FIG. 2 is a flowchart showing overall processing steps 200 of an exemplary embodiment of the distribution adjustment process carried out by the distribution adjustment engine 100 of the present disclosure. Beginning in step 202, a vector V (e.g., a set) of data elements (e.g., observations) is programmatically identified. The vector V of data elements can include data corresponding to, for example, obtained, collected, measured, observed, predicted, and/or probabilistic data, which can be stored in a non-transitory computer-readable storage medium. The vector V can be an input to the distribution adjustment engine 100 and can have an initial distribution.

The initial distribution of the vector V of data elements can be represented as a histogram having a vector of bins B=[b₁, b₂, . . . , bₘ]^{T}, where each data element in the vector V can be associated with one of the bins of the histogram. The histogram can be denoted as Q=H(V,B), which is a vector Q=[q₁, q₂, . . . , qₘ]^{T}, where qⱼ is the quantity of data elements (e.g., observations) of the vector V that fall into a bin bⱼ. Consider vᵢ, for i=1, 2, . . . , n, as the i th data element of vector V, and let cⱼ and eⱼ represent the center and the left edge of bⱼ, respectively. Let eₘ₊₁ be the right edge of the last (m th) bin.

In step 204, a reference distribution is identified. The reference distribution can correspond to a specified distribution, which can be a generic distribution, such as a normal or Gaussian distribution (e.g., the bell curve) or a custom distribution (e.g., a distribution based on past data that does not correspond to a generic distribution). Selection of a particular distribution can be based on the type and/or application associated with the data elements in the vector V. For example, for embodiments in which the data elements correspond to predictions of a future event based on past data, a distribution of at least the past data can be used to generate the reference distribution. The reference distribution can be an input to the distribution adjustment system.

In step 206, the data elements of vector V are programmatically modified by the system to adjust the initial distribution to generate a modified distribution that more closely resemble the reference distribution than the initial distribution of the data elements.

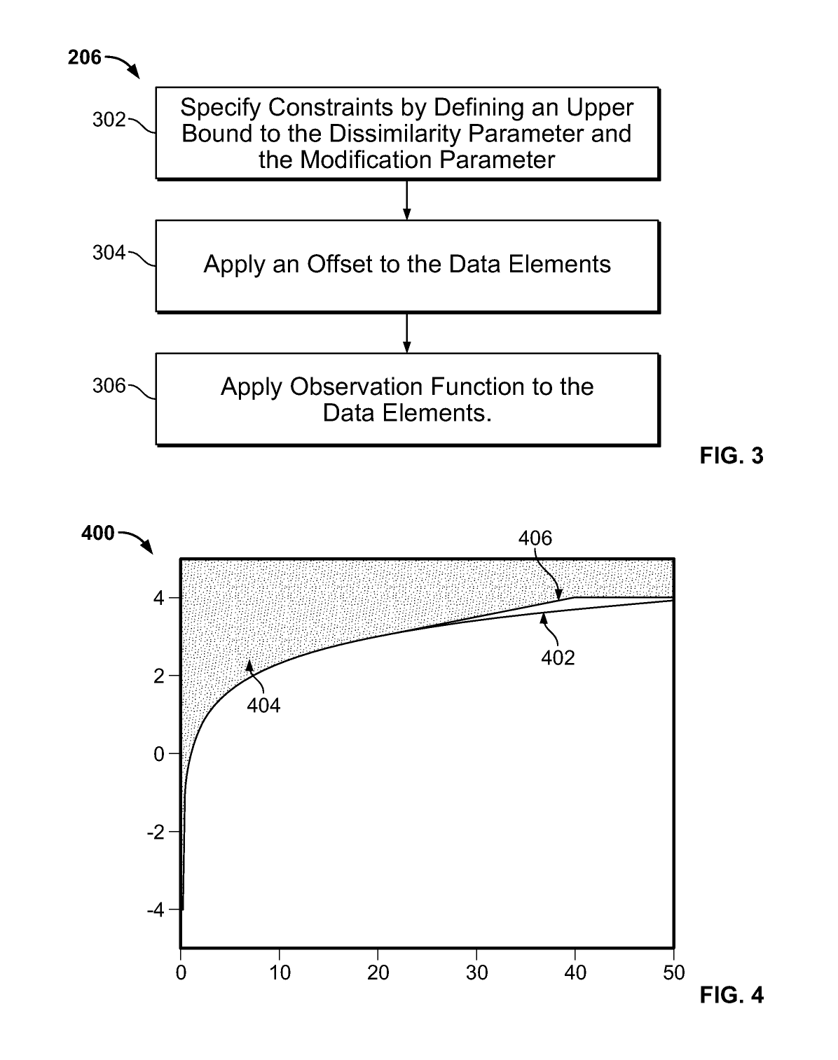

FIG. 3 is a flowchart showing an exemplary embodiment of processing step 206 in more detail. The engine 100 can programmatically generate the modified distribution based on one or more constraints for one or more parameters associated with the initial distribution, the modified distribution, and/or the reference distribution. For example, the engine 100 can be programmed and/or configured to balance a dissimilarity parameter associated with the initial or modified distribution and the reference distribution with a modification parameter corresponding to the extent to which the data elements of vector V are modified. The engine 100 can be programmed and/or configured to balance the dissimilarity between the modified distribution and reference distribution to the extent to which the data elements of the vector V are modified according to the one or more constraints to adjust the distribution of the set of data elements so that the distribution of the set of data elements more closely resembles the reference distribution. In exemplary embodiments, in step 302, the engine 100 can be programmed and/or configured to specify an upper bound for dissimilarity parameter and an upper bound for the modification parameter to minimize these parameters and optimize the adjustment of the initial distribution.

To modify the vector V, in step 304, a vector of offset values can be programmatically added to the vector V by the system (in order for it to have a histogram similar to the reference histogram). The vector of offset values can be denoted as X=[x₁, x₂, . . . , xₙ]^{T}, where x₁ s are unrestricted in sign. A matrix of binary variables Y=[yᵢⱼ] for i=1, 2, . . . , n and j=1, 2, . . . , m can be introduced, where yᵢⱼ=1 if vᵢ+xᵢ falls into bin bⱼ, and yᵢⱼ=0 otherwise. Let also pⱼ, the j th element of vector P, be the population of bⱼ in the reference histogram, and qⱼ, the j th element of vector Q be the population of bⱼ in H(V+X,B). For any vector A we define

$$\overline{A} = \frac{A}{{‖ A ‖}_{1}} .$$

In an exemplary embodiment, it can be assumed that v₁≦v₂≦ . . . ≦vₙ.

Given initial data elements in the vector V, the vector of bins B, and reference histogram P̅ defined with respect to the vector of bins B, the following provides a general framework of the engine 100 for programmatically optimizing the histogram adjustment process:

$$\begin{matrix}Min f ( δ , σ ) & ( 1 ) \\ s . t . {\sum }_{j = 1}^{m} {y}_{i , j} = 1 ∀ i = 1 , 2 , … , n & ( 2 ) \\ {\sum }_{i = 1}^{n} {y}_{i , j} = {q}_{j} ∀ j = 1 , 2 , … , m & ( 3 ) \\ {v}_{i} + {x}_{i} ∈ {b}_{j} for a j ∀ i = 1 , 2 , … , n & ( 4 ) \\ ‖ X ‖ \leq δ & ( 5 ) \\ d ( \overline{P} , \overline{Q} ) \leq σ . \\ X ∈ {R}^{n} , Y ∈ {\{ 0 , 1 \}}^{n \times m} , & ( 6 ) \\ σ ∈ R , δ ∈ {R}_{+} , Q ∈ {( {Z}_{+} ⋃ \{ 0 \} )}^{m} . & ( 7 )\end{matrix}$$

In step 306, the observation function in Equation (1) above is applied to the data elements based on the constraints in Equations (2)-(7), where δ denotes the modification parameter and σ denotes the dissimilarity parameter. The constraint set of Equation (2) guarantees that each observation after modification falls into exactly one of the bins. The constraint set of Equation (3) gives the population of each bin after modification. These two families of constraints are straightforward. The constraint of Equation (5) puts a limit on the size of the modifications made to the data elements of the vector V, and the constraint of Equation (6) puts an upper bound on the dissimilarity between the reference histogram and the histogram of the modified data elements. There are various ways to rigorously formulate the constraints of Equations (4), (5), and (6), as discussed in more detail below.

In order to make a modified data element vᵢ+xᵢ fall into bin bⱼ, two approaches are considered: discrete and continuous. In the discrete approach, vᵢ+xᵢ is forced to be equal to the center cⱼ of bⱼ, and the constraint (4) can be formulated as follows:

$${v}_{i} + {x}_{i} = {\sum }_{j = 1}^{m} {y}_{i , j} {c}_{j} .$$

This constraint assigns the value cⱼ, the center of bin bⱼ, to vᵢ+xᵢ when y_{i,j} is equal to 1. Using this approach, the data elements (even the ones that will stay in their original bin after applying the modifications) are moved to the centers of the bins. Moving the data elements that don't move to a different bin after applying the modifications does not have any effect on the shape of the histograms. Specifically, assume that v_{i′} is in b_{j′} and v_{i′}+x_{i′}=c_{j′} i.e., v_{i′}+x_{i′} is in b_{j′}, as well. This means that applying the modifications would not change the bin that observation i′ falls into. Therefore, for such data elements, one might choose not to apply the modification for the data elements that are staying in their original bin after applying the modifications.

On the other hand, in the continuous approach, the offset value xᵢ is selected such that xᵢ+vᵢ falls somewhere in the interval [eⱼ,eⱼ₊₁] for some j (eⱼ is the left edge of bⱼ). Using this approach, the constraint of Equation (4) can be formulated as follows:

$${v}_{i} + {x}_{i} = {\sum }_{j = 1}^{m + 1} {λ}_{i , j} {e}_{j} ,$$

where new variables λ_{i,j} are subject to the following constraints:

$${λ}_{i , j} ∈ [ 0 , 1 ] ∀ i = 1 , 2 , … , n ; ∀ j = 1 , 2 , … , m + 1$$

$${\sum }_{j = 1}^{m + 1} {λ}_{i , j} = 1 ∀ i = 1 , 2 , … , n ,$$

and for each i, for only two consequetive j s λ_{i,j} can take a postive value. Therefore, λ_{i,j} s are Special Ordered Sets of type 2 (SOS2) variables. These constraints indicate that vᵢ+xᵢ is a convex combination of the edges of the bins. The typical way of modeling SOS2 variables is to add the following constraints:

λ_{i,1}≦y_{i,1}

λ_{i,j}≦y_{i,j-1}+y_{i,j} ∀i=1,2, . . . ,n; j=2, . . . ,m

λ_{i,m+1}≦y_{i,m}

Addition of these constraints can guarantee that for each i only two consecutive j s λ_{i,j} can take a nonzero value, and, as a result, vᵢ+xᵢ becomes the convex combination of two consecutive bin edges.

Notice that, since in Equations (1)-(7) above, minimizing the size of X is one of the components of the objective function (see Equations (1) and (5)), if xᵢ is in bⱼ and xᵢ+vᵢ falls into b_{j′} and j≠j′, it is guaranteed for its value to be equal to eⱼ or eⱼ₊₁ (whichever is closer to xᵢ).

A number of measures of dissimilarity between the histogram of the vector V and the target histogram are set forth according to exemplary embodiments of the present disculosure. In some embodiments, in order to have a reasonable computational complexity, dissimilarity measures that have a number of desirable properties can be used. One property of a dissimilarity measure can be that the dissimilarity measure is defined bin-by-bin—i.e., obtained by comparing the pairs of bins of the same index in the two histograms, as opposed to cross-bin measures. Another property of the dissimilarity measures can be that these measures (except the Lₒ distance) are convex functions of the bin populations of the histogram of the data elements, so that using them adds convex constraints to Equation (1). One or more of the properties of the dissimilarity measures can be represented by linear constraints.

One exemplary dissimilarity measure that can be implemented by the system can be the Minkowski distance. The Minkowski distance of order t, or in short, the Lₜ distance between histograms P and Q is given by

$${d}_{{L}_{t}} ( P , Q ) = {( {\sum }_{j} {\vert {p}_{j} - {q}_{j} \vert}^{t} )}^{1 / t} \qquad ( 8 )$$

Among different choices for the order t of the Minkowski distance to be used in Equation (1), the following are the most common:
1. t=1: If we interpret the histograms P and Q as two categorical probability distributions, the L₁ distance d_{L}_{₁}(P,Q) will correspond to the total variation distance of these two probability measures. In other words, the constraint L_{L}_{₁}(P,Q)≦σ puts an upper limit on the largest possible difference between the probabilities that the two distributions P and Q can assign to the same event. Using this constraint tends to limit the number of bins where the two histograms P and Q differ to a relatively small number. A major advantage of this constraint is that it can be enforced in (1) by a set of linear inequalities.
2. t=2: This is the Eucleadian distance between P and Q, and using it in (1) turns the problem into a mixed-integer quadratic programming (MIQP) problem.
3. t=∞: The constraint d_{L}_{_{∞}}(P,Q)≦σ asserts that the maximum pair-wise difference between the corresponding elements of P and Q does not exceed σ. This constraint, similar to L₁, can be enforced by a set of linear inequalities.
4. t=0: The L₀ distance does not satisfy the properties of a proper metric. The constraint d_{L}_{₀}(P,Q)<σ upper bounds the number of bins where the two histograms differ. Although not a convex constraint in terms of Q, this constraint can be formulated in (1)-(7) using a number of linear constraints with the help of some of the binary variable.

Another dissimilarity measure that can be implemented by the system can be the scaled distances measure, which, instead of directly computing the Minkowski distances between the vectors P and Q, the element-wise error between the two vectors is scaled, giving a weight wⱼ to each bin j. Using this approach, the scaled Lₜ distance can be given by:

$${d}_{{L}_{t} , Scaled} ( P , Q ) = {( {\sum }_{j} {\vert {w}_{j} ( {p}_{j} - {q}_{j} ) \vert}^{t} )}^{1 / t}$$

One possible choice for the weights is to set

$${w}_{j} = \frac{1}{{p}_{j}} ,$$

j=1, 2, . . . , m. In this case, the penalty is put on the relative errors in the populations of the bins, rather than their absolute errors.

Another disimilarity measure that can be implemented by the system includes the Kullback-Leibler (KL) Divergence dissimilarity measure. The KL divergence (also referred to as relative entropy) between two probability distributions P and Q measures the expected number of extra bits needed to compress samples generated from P using a code based on Q, rather than a code based on the true distribution, P. The KL divergence can be implmented in various applications that require a measure of dissimilarity between probability measures, such as in information theory, image processing, and machine learning.

If probability mass functions P=[p₁, p₂, . . . , pₘ]^{T} and Q=[q₁, q₂, . . . , qₘ]^{T} are defined for a discrete random variable, their KL divergence is given by:

$${d}_{KL} ( P , Q ) = {\sum }_{j = 1}^{m} {p}_{j} log \frac{{p}_{j}}{{q}_{j}} \qquad ( 10 )$$

The natural base “e” is used for logarithms unless otherwise indicated. The KL divergence d_{KL}(P,Q) does not satisfy the requirements of a proper distance between P and Q, and in particular, it is not symmetric with respect to P and Q.

In exemplary embodiments, P is a known parameter and Q is a problem variable. Although d_{KL}(P,Q) is a convex function of Q, its logarithmic form prevents representing it by linear constraints, and hence making Equations (1)-(7) a mixed-integer linear program (MILP). In some embodiments, the log function can be approximated as a piecewise linear function.

To use the KL divergence as the measure of dissimilarity, the constraint in Equation (6) is replaced with:

$${\sum }_{j = 1}^{m} {p}_{j} log \frac{{p}_{j}}{{q}_{j}} \leq σ \qquad ( 11 )$$

or its equivalent:

$${\sum }_{j = 1}^{m} {p}_{j} log \frac{{q}_{j}}{{p}_{j}} \geq - σ . \qquad ( 12 )$$

Now suppose the function log(x) is approximated as the minimum over K lines; i.e.,

$$log ( x ) \approx g ( x ) \\ {=}^{Δ} {min}_{k = 1 , … , K} {a}_{k} x + {b}_{k} . \qquad ( 13 )$$

Using the above, a piecewise linear approximation to the constraint (12) as a number of constraints linear in qⱼ:

$$\begin{matrix}{\sum }_{j = 1}^{m} {p}_{j} {g}_{j} \geq - σ & ( 14 ) \\ {g}_{j} \leq {a}_{k} \frac{{q}_{j}}{{p}_{j}} + {b}_{k} , k = 1 , … , K , j = 1 , … , m . & ( 15 )\end{matrix}$$

In addition to the K constraints of Equation (15), two additional constraints can be added to maintain stability of an approximation of the log function. The two constraints can be represented as follows:

$$\begin{matrix}{g}_{j} \leq α , & ( 16 ) \\ \frac{{q}_{j}}{{p}_{j}} \geq β . & ( 17 )\end{matrix}$$

As one approach for defining the lines used in (13), let z₁, z₂, . . . , z_{K} be K positive numbers. The function log(x) for x≈zᵢ can be approximated by the affine function representing the tangent of log(x) at x=zᵢ; i.e.,

$$log ( x ) \approx {a}_{i} x + {b}_{i} , \\ where$$

$$\begin{matrix}{{a}_{i} = \frac{d log ( x )}{d x} \vert}_{x = {z}_{i}} \\ = \frac{1}{{z}_{i }} ,\end{matrix}$$

$$and$$

$$\begin{matrix}{b}_{i} = log ( {z}_{i} ) - {a}_{i} {z}_{i} \\ = log ( {z}_{i} ) - 1.\end{matrix}$$

Given an interval of interest on the x-axis for approximating log(x), {zᵢ} can be chosen such that {log(zᵢ)} are uniformly spaced. FIG. 4 shows a graph 400 providing an example of approximating the log curve 402 to linearize the log function. The lines 404 are the tangents of the log curve and the curve 406 is the upper approximation of the log function, obtained by taking the minimum over the lines 404.

The data elements of vector V can be programmatically modified while constraining the extent to which the data elements of the vector V are modified based on measures of change. In exemplary embodiments, the Lₜ norms of the change vector, X, with different orders, t can be used. Similar to the disimilarity measures described above, L₁, L₂, L_{∞}, and L₀ are representative of some orders for the measure of change. The constraints on each norm can be enforced by the system according to the contraints set forth in Equations (1)-(7) in a similar way as described herein with respect to the dissimilarity measures.

The objective function set forth in Equation (1) of the MIP problem can be defined to be a function of the right-hand side of the constraints set forth in Equations (5) and (6). In an exemplary embodiment, the engine 100 can be programmed and/or configured to minimize a combination of modification ∥X∥ on the data elements and the dissimilarity d( P̅, Q̅) between the two histogram after modifications. This objective function can be tuned to put the proper emphasis on minimizing the modification and/or dissimilarity.

As a special case, if we define the objective as ƒ(δ,σ)=σ, all the emphasis will be put on minimizing the distribution dissimilarity, and an operation of the system can be reduced to histogram matching.

In exemplary embodiments, other sets of constraints can implemented by the system. For example, a set of contraints can be programmatically implemented by the system that are satisfied at the optimal solution of the objective function of Equation (1), but may not be satisfied by every feasible solution of objective function of Equation (1) such that these constraints can be considered as valid constraints for histogram adjustment but not for the formulation of the objective function of Equation (1) of the histogram adjustment problem. In order to motivate these constraints, first consider the following Lemma:

Lemma 1 Suppose a₁, a₂, b₁, b₂εR and we have a₁≦a₂ and b₁≦b₂. Then for |a₁−b₁|^{t}+|a₂−b₂|^{t}≦|a₁−b₂|^{t}+|a₂−b₁|^{t}.

Proof. The lemma for two cases which, together, cover all the possibilities can be proved by:
1. b₁≦a₁≦a₂≦b₂
   Clearly, |a₁−b₁|≦|a₂−b₁| and |a₂−b₂|≦|a₁−b₂|. It suffices to add the two inequalities after taking both sides of each to the t th power.
2. Either a₁≦b₁≦b₂ or b₁≦b₂≦a₂ Due to symmetry, it is sufficient to prove the lemma for the case b₁≦b₂≦a₂. We can write

|a₂−b₁|^{t}=|a₂−b₂|+|b₂−b₁∥^{t}≧|a₂−b₂|^{t}+|b₂−b₁|^{t}, (18)
since t≧1, and

|a₁−b₂|^{t}+|b₂−b₁|^{t}≧|a₁−b₁|^{t}, (19)
due to the Minkowski inequality. Adding Equations (18) and (19) and canceling |b₂−b₁|^{t} from the two sides completes the proof.

Proposition 1 It can be assumed that in formulation (1) the function ƒ(δ,σ) is a non-decreasing function of δ, and in (5) a distance norm Lₜ with t≧1 is used. Then, there is an optimum solution to (1) at which the offset variables X*=[x₁*, x₂*, . . . , xₙ*]^{T} satisfy:

vₖ+xₖ*≦vₗ+xₗ*∀k,l for which vₖ≦vₗ.

so that the order of the observations is preserved after solving Equation (1).

Proof. It is sufficient to prove that any feasible solution not satisfying Equation (1) can be modified into a new feasible solution that satisfies Equation (1) without increasing the objective (cost) function. This can be shown by defining uᵢ*Δvᵢ+xᵢ* for each i, and supposing in a feasible solution that uₖ*>uₗ* for some k and l for which vₖ≦vₗ. Replacing the offset variables xᵢ* with the new offset variables:

$${\tilde{x}}_{i} = \{ \begin{matrix}{u}_{l}^{*} - {v}_{k} & if i = k , \\ {u}_{k}^{*} - {v}_{l} & if i = l , \\ {x}_{i}^{*} & for all other values of i .\end{matrix}$$

results in the new values of the modified observations k and l being swapped. This swapping does not change the histogram of the modified observations, and hence, the corresponding histogram dissimilarity set forth in Equation (6). Furthermore, ∥\tilde{X}∥ₜ≦∥X∥ₜ, since:

$$\begin{matrix}{‖ \tilde{X} ‖}_{t}^{t} - {‖ {X}^{*} ‖}_{t}^{t} = {\vert {\tilde{x}}_{k} \vert}^{t} + {\vert {\tilde{x}}_{l} \vert}^{t} - {\vert {x}_{k}^{*} \vert}^{t} - {\vert {x}_{t}^{*} \vert}^{t} \\ = {\vert {u}_{l}^{*} - {v}_{k} \vert}^{t} + {\vert {u}_{k}^{*} - {v}_{l} \vert}^{t} -- {\vert {u}_{k}^{*} - {v}_{k} \vert}^{t} - {\vert {u}_{l}^{*} - {v}_{l} \vert}^{t} \leq 0 ,\end{matrix}$$

with the last inquality obtained by applying Lemma 1. This means that the size of the modification made to the observations in Equation (5) has not increased as a result of this swap. Using the these values for xᵢ, an alternative feasible solution to Equation (1) can be achieved without increasing the objective function. There may still be other pairs (k,l) for which Equation (1) is not satisfied, but this process of swapping can be repeated without increasing the objective function, until Equation (1) is satisfied for all pairs (k,l).

Based on Proposition 1, an optimum solution to Equation (1) can be found for which the order of observations does not change as a result of histogram adjustment.

Corollary 1 For all i, iε{1, 2, . . . , n} and j, j′ε{1, 2, . . . , m} such that

i<i′ j>j′

the following inequality holds for (X*,Y*):

y_{i,j}*+y_{i′,j′}*≦1. (20)

This corollary indicates that if i<i′ and j>j′ then y_{i,j}* and y_{i′,j′}* both cannot be equal to 1, which would mean that after assigning the original observations to some bins, their relative order may not be switched.

Both sets of inequalities set forth in Equations (1)-(6) and (20) can be added to the MIP formulation of the problem in Equation (1) in order to restrict the search space of the problem. There are n−1 inequalities of form set forth in Equations (1)-(6). The number of inequalities in Equation (20) is O(n²m²) and none, all, or some of this inequalities can be incorporate in the process of solving Equation (1). For example, these constraints can be used in a branch and cut framework and at each node of the branch and bound tree can add some of these constraints that are violated at that node. In a cut and branch framework, some of these inequalities can be added at the root node and then regular branching can be used.

A simpler way of exploiting these constraints is that whenever an integer feasible solution is found, it can be determined whether the order of observations is preserved. If not, it can be ensured that the inequalities of Equation (2) are satisfied by simply changing the modifications of observations. For example, consider an integer feasible solution (\hat{X},Ŷ) and suppose that i<i′ and j>j′, and also ŷ_{i,j} and ŷ_{i′,j′} are both equal to 1. In this case by enforcing

ŷ_{i,j}=0 ŷ_{i,j′}=1 ŷ_{i′,j′}=0 ŷ_{i′,j}=1

and changing \hat{x}ᵢ and \hat{x}_{i′} accordingly so that vᵢ+\hat{x}ᵢ falls into b_{j′} and vᵢ+\hat{x}_{i′} falls into bⱼ, the new solution satisfies ŷ_{i,j}+ŷ_{i′,j′}≧1. When using this reordering as a post-processing step, the final modified observations can be obtained. When the initial observations are sorted, only the modified observations, vᵢ+xᵢ, output by the MILP are sorted and reindexed—in O(n log n) time.

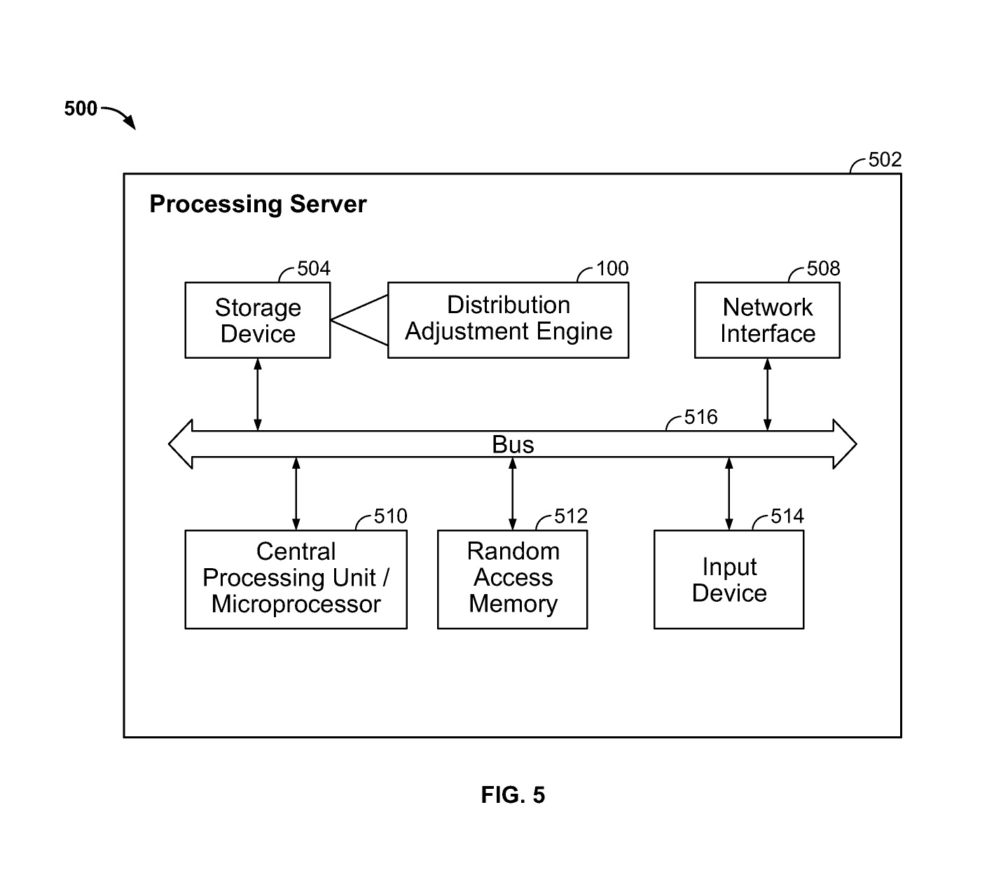

FIG. 5 is a diagram showing hardware and software components of an exemplary system 500 capable of performing the processes discussed above. The system 500 includes a processing server 502, e.g., a computer, and the like, which can include a storage device 504, a network interface 508, a communications bus 516, a central processing unit (CPU) 510, e.g., a microprocessor, and the like, a random access memory (RAM) 512, and one or more input devices 514, e.g., a keyboard, a mouse, and the like. The processing server 502 can also include a display, e.g., a liquid crystal display (LCD), a cathode ray tube (CRT), and the like. The storage device 504 can include any suitable, computer-readable storage medium, e.g., a disk, non-volatile memory, read-only memory (ROM), erasable programmable ROM (EPROM), electrically-erasable programmable ROM (EEPROM), flash memory, field-programmable gate array (FPGA), and the like. The processing server 502 can be, e.g., a networked computer system, a personal computer, a smart phone, a tablet, and the like.

In exemplary embodiments, the distribution adjustment engine 100 can be embodied as computer-readable program code stored on one or more non-transitory computer-readable storage device 504 and can be executed by the CPU 510 using any suitable, high or low level computing language, such as, e.g., Java, C, C++, C#, .NET, and the like. Execution of the computer-readable code by the CPU 510 can cause the engine 100 to implement an embodiment of the distribution adjustment process. The network interface 508 can include, e.g., an Ethernet network interface device, a wireless network interface device, any other suitable device which permits the processing server 502 to communicate via the network, and the like. The CPU 510 can include any suitable single- or multiple-core microprocessor of any suitable architecture that is capable of implementing and/or running the engine 100, e.g., an Intel processor, and the like. The random access memory 512 can include any suitable, high-speed, random access memory typical of most modern computers, such as, e.g., dynamic RAM (DRAM), and the like.

Exemplary experiments implementing exemplary embodiments of the distribution adjustment process are provided herein using linear constraints that are continuous or discrete. Both the discrete and the continuous approaches used to formulate constraints of Equation (4) provide linear constraints as described herein. In the case of the constraints of Equation (5), distance norms L₀, L₁, and L_{∞} can be formulated linearly as described herein. Finally, as far as the constraints of Equation (6) are concerned, Minkowski and Scaled distance norms for t equal to 0, 1, ∞ can be linearly formulated. Moreover, a linear approximation for the KL divergence can be defined as described herein. While exemplary experiments illustrate an application of embodiments of the distribution adjustment process to a regression problem, those skilled in the art will recognize that applications of exemplary embodiments of the distribution adjustment process is not limited such regression problems.

An Open Solver Interface (OSI) that provides a C++ interface to linear solvers (OSI 2000) was used. For the MILP solver to solve the models built in OSI, COIN-Cbc2.7 (Forrest, 2004) was used, which is an open-source MILP solver. Commercial solvers such as CPLEX (CPL, 2011) and Gurobi (Gur, 2009), which are generally faster and more numerically stable than COIN-Cbc, can also be used.

In a first set of experiments, data from the Heritage Health Provider Network (HHP) was used as the benchmark problem to evaluate a performance of exemplary embodiments of the present disclosure. The data includes information on claims submitted by patients of the HHP, and based on this information, predictions of the number of days each patient will spend in hospital during the following year are calculated. The value of number of days in hospital for next year can be denoted as DIH. The data from which the predictions are calculated includes three years of claims level information such as member ID, age, primary care provider, specialty, charlson index, place of service, and length of stay. Also, the data includes some information about drugs and lab tests provided for the patients. Moreover, for each patient with claims in years 1 and 2, it is known that how many days they stayed in hospital in the next year.

Using this information predictions of how many days each patient will stay in the hospital in year 4 is determined, and the score of these predictions is calculated as:

$$ɛ = \sqrt{\frac{1}{n} {\sum }_{i = 1}^{n} {[ log ( {p}_{i} + 1 ) - log ( {a}_{i} + 1 ) ]}^{2}} ,$$

where aᵢ is the actual number of days member i spent in hospital during the test period, and pᵢ is the predicted number of days member i spent in hospital in the test period.

Based on the claims information of the patients, for all of the patients a set of features is developed that captures the patients claims, lab and drugs information. The label for each record (each record is a patient in year one, two, or three) is the number of days the patient spent in hospital in the next year (DIH). This results in training and the test sets with the general structure of the Table 1.

TABLE 1
Training set: DIH is given; test set: DIH to be predicted

| | Year | | DIH |
|---|---|---|---|
| ID | 1 or 2 | Features | 2 or 3 |
| | | | Known |
| ID | Year 3 | Features | DIH 4 |
| | | | Unknown |

The part of the training set that corresponds to year 1 is used as the training set and the rest (records corresponding to year 2) as the test set. Since the DIH values for year 2 are available, the score can be computed without submitting predictions.

For computation purposes, a linear regression model was trained on data for year 1 and used to predict DIH for year 3 on 1000 patients. These predictions are considered to be an initial set or vector of data elements for which distribution adjustment is performed. For the experiments, it is assumed that the distribution of DIH in year 3 is very similar to the distribution of DIH in year 2.

A fundamental difference between the distributions of the actual values of DIH for year 2 and the predicted values of DIH for year 3 (coming from linear regression) is that the former has a discrete distribution on integer numbers, whereas the latter is a continuous distribution over real numbers. To overcome this issue, a continuous distribution was fit to the discrete values of DIH in year 2. For this purpose, the actual DIH to be the results of quantizing i.i.d. realizations of a random variable is modeled with a χ² distribution of one degree of freedom. In particular, it is assumed that DIH is equal to round(αX), where α=0.467, and X is a nonnegative random variable from a λ₁² distribution, i.e.:

$${f}_{X} ( x ) = \frac{1}{\sqrt{2 π x}} {e}^{- x / 2} .$$

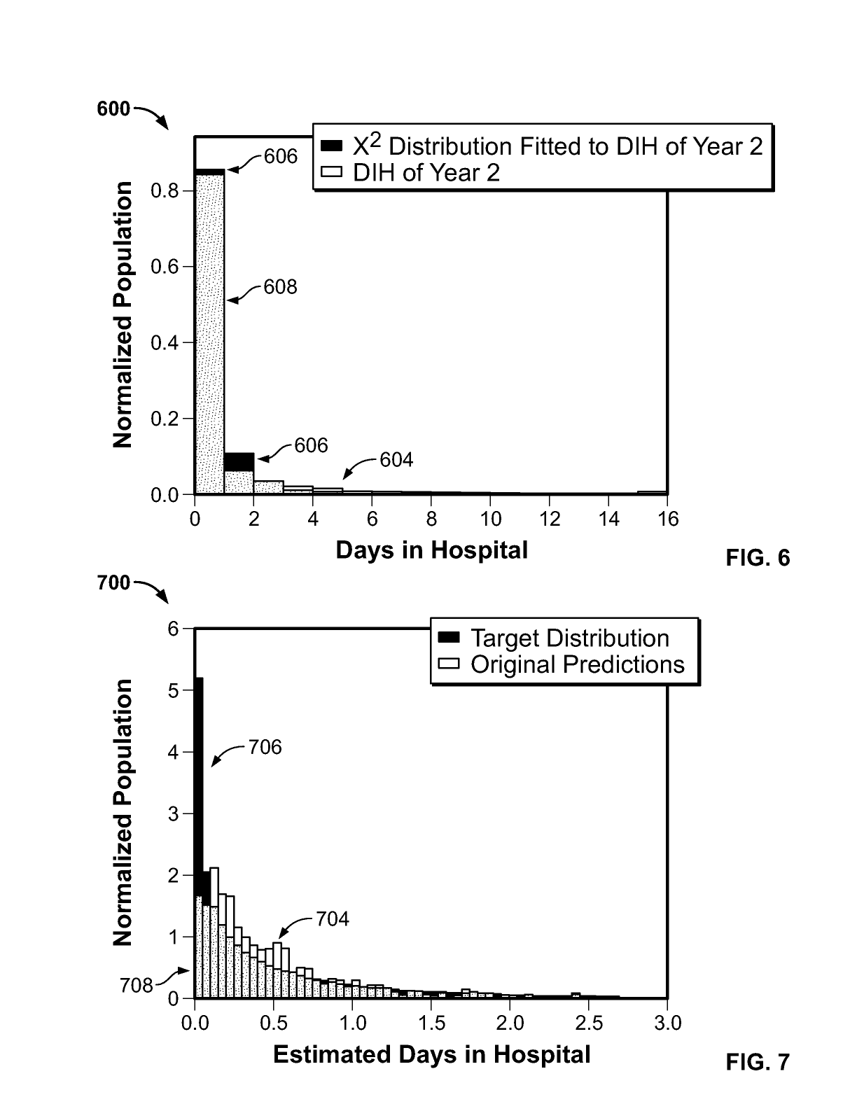

The original histogram of DIH of year 2, as well as its fitted χ₁² approximation quantized with a bin width of 1. FIG. 6 is a graph 600 showing the actual DIH values 604 for year 2, a fitted χ₁² distribution 606 and an overlap 608 therebetween.

Having a continuous distribution that fits well to DIH in year 2, the continuous distribution can be discretized to any level (bin width) and can be used as the target or refernce histogram. Throughout the experiments the bin width was set to a value of 0.05. FIG. 7 is a graph 700 showing the DIH values predicted for year 3. The graph 700 includes a target histogram 704 obtained from a χ₁² distribution fitted to distribution 706 of the DIH in year 2 and an overlap 708 therebetween.

The number of variables and constraints in the formulation of the object function of Equation (1) linearly depend on the number of observations we work with. Therefore, the MILP problem that must be solved could become so large in size (if too many observations are considered) that it becomes intractable to solve. One way around this issue is to group some number of observations that are close to one another and consider them as one observation. In that case, the change found by the MILP problem for an aggregate observation propagates to all the observations in the group.

One can also tackle larger problems by using commercial MILP solvers such as CPLEX and Gurobi, which are significantly faster than the open-source solvers.

In all of the experiments, the objective is to minimize the amount of modification that is made to the observations. The discrete formulation throughout this section and the dissimilarity parameter σ is set to a constant value. In the first experiment, the KL divergence for the dissimilarity measure is used and the L₁ norm for the measure of modification is used. The resulting MIP is the following:

$$\begin{matrix}Min δ & ( 22 ) \\ s . t . {\sum }_{j = 1}^{m} {y}_{i , j} = 1 \\ ∀ i = 1 , 2 , … , n & ( 23 ) \\ {\sum }_{i = 1}^{n} {y}_{i , j} = {q}_{j} \\ ∀ j = 1 , 2 , … , m & ( 24 ) \\ {v}_{i} + {x}_{i} = {\sum }_{j = 1}^{m} {y}_{i , j} {c}_{j} \\ ∀ i = 1 , 2 , … , n & ( 25 ) \\ {x}_{i} - {α}_{i} \leq 0 \\ ∀ i = 1 , 2 , … , n & ( 26 ) \\ - {x}_{i} - {α}_{i} \leq 0 \\ ∀ i = 1 , 2 , … , n & ( 27 ) \\ {\sum }_{i = 1}^{n} {α}_{i} \leq δ & ( 28 ) \\ {\sum }_{j = 1}^{m} {p}_{j} {g}_{j} \leq σ & ( 29 ) \\ {g}_{j} \leq {a}_{k} \frac{{q}_{j}}{{p}_{j}} + {b}_{k} \\ ∀ k = 1 , 2 , … , K \\ ∀ j = 1 , 2 , … , m & ( 30 ) \\ X ∈ {R}^{n} , Y ∈ {\{ 0 , 1 \}}^{n \times m} , \\ σ ∈ R , δ ∈ {R}_{+} , Q ∈ {( {Z}_{+} ⋃ \{ 0 \} )}^{m} . & ( 31 )\end{matrix}$$

The constraints of Equations (26)-(28), which indicate ∥X∥₁≦δ, impose the constraint of Equation (5); i.e., they restrict the amount of modifications on the observations. Moreover, the constraints of Equations (29) and (30) represent the constraint of Equation (6) which indicates d( P̅, Q̅)≦σ in the original MIP formulation in Equation (1).

In the second experiment a scaled dissimilarity measure with order t=1 is used and, similar to the first experiment, the L₁ norm for the measure of modification is used. The following is the resulting MILP formulation:

$$\begin{matrix}Min δ & ( 32 ) \\ s . t . {\sum }_{j = 1}^{m} {y}_{i , j} = 1 \\ ∀ i = 1 , 2 , … , n & ( 33 ) \\ {\sum }_{i = 1}^{n} {y}_{i , j} = {q}_{j} \\ ∀ j = 1 , 2 , … , m & ( 34 ) \\ {v}_{i} + {x}_{i} = {\sum }_{j = 1}^{m} {y}_{i , j} {c}_{j} \\ ∀ i = 1 , 2 , … , n & ( 35 ) \\ {x}_{i} - {α}_{i} \leq 0 \\ ∀ i = 1 , 2 , … , n & ( 36 ) \\ - {x}_{i} - {α}_{i} \leq 0 \\ ∀ i = 1 , 2 , … , n & ( 37 ) \\ {\sum }_{i = 1}^{n} {α}_{i} \leq δ & ( 38 ) \\ ( {q}_{j} - {p}_{j} ) - {β}_{j} \leq 0 \\ ∀ j = 1 , 2 , … , m & ( 39 ) \\ - ( {q}_{j} - {p}_{j} ) - {β}_{j} \leq 0 \\ ∀ j = 1 , 2 , … , m & ( 40 ) \\ \sum \frac{{β}_{j}}{{p}_{j}} \leq σ & ( 41 ) \\ X ∈ {R}^{n} , Y ∈ {\{ 0 , 1 \}}^{n \times m} , \\ σ ∈ R , δ ∈ {R}_{+} , Q ∈ {\{ {Z}_{+} ⋃ \{ 0 \} )}^{m} . & ( 42 )\end{matrix}$$

Notice that inequalities of Equations (39)-(41) are equivalent to

$${\sum }_{j = 1}^{m} \frac{\vert {q}_{j} - {t}_{j} \vert}{{t}_{j}} \leq σ$$

which represents equation (9) with t=1 and wⱼ=pⱼ.

The experiments were run on a machine with an 2.67 GHz Intel Xeon CPU and 8 GB of RAM. The time limit on each run is set to 300 seconds. In these experiments we change the value of the dissimilarity parameter σ, which is an upper on the dissimilarity measure, and report the score of resulting modifications and also the amount of modification. To avoid statistical inaccuracy we ignore the bins that according to the target distribution are supposed to have a very small number of observations (less than 5 observations in this case). Table 2 summarizes these numbers. The table presents the results for the formulations (22)-(31) and (32)-(42) and with different values of the dissimilarity parameter σ. The column “Score” shows the score of the modified observations for the corresponding the dissimilarity parameter σ value. The column “Mod.” is the amount of modifications to the observations, i.e. the objective value of the solution, and column “Gap %” is the relative gap to optimal solution at the current solution. Finally, the column “Ord. Mod. Score” shows the score of the modified observation after applying the order constraints as described herein.

The score of the original observations is 0.516934. Notice that the smaller the value of the dissimilarity parameter σ, the better the score and, on the other hand, the higher the size of modification to the observations. Generally for different applications one might need to come up with a balance between the amount of modification and the value of σ. Furthermore, notice that after applying the order constraints to the solution, the score improves. Applying the order constraints leaves the value of the dissimilarity parameter σ intact, and yet decreases the amount of modifications on observations. The number in Table 2 show that for the same value for the dissimilarity parameter σ lower modification (ordered modification) results in higher score.

TABLE 2
Score, amount of modification, optimality gap, and score of
modification after applying order constraints for two formulations
(with KL and scaled L1 dissimilarity measure) and different values
for the dissimilarity parameter σ.

| Dist. | σ | Score | Mod. | Gap % | Ord. Score |
|---|---|---|---|---|---|
| KL | 0.0001 | 0.493549 | 137.60 | 0.89 | 0.487440 |
| | 0.01 | 0.499182 | 102.23 | 6.34 | 0.498108 |
| | 0.1 | 0.506763 | 53.87 | 0.11 | 0.506973 |
| | 1 | 0.507424 | 47.91 | 0.00 | 0.507424 |
| | 10 | 0.507424 | 47.91 | 0.00 | 0.507424 |
| Scl. L1 | 2 | 0.488059 | 148.55 | 0.18 | 0.485999 |
| | 10 | 0.500234 | 73.54 | 0.00 | 0.499348 |
| | 20 | 0.507017 | 48.62 | 0.08 | 0.506982 |
| | 40 | 0.507424 | 47.91 | 0.00 | 0.507424 |

Another pattern in Table 2 is that the optimality gap for these problems after 300 seconds is generally very low, and for some of the cases the MILP problems are even solved to optimality during these 300 seconds. In other words, despite the large size of the problems (36034 columns and 4919 rows for the KL formulation; 36034 columns and 4069 rows for the scaled L1 formulation) and the use of open-source solvers, the MILP can still be solved rather quickly.

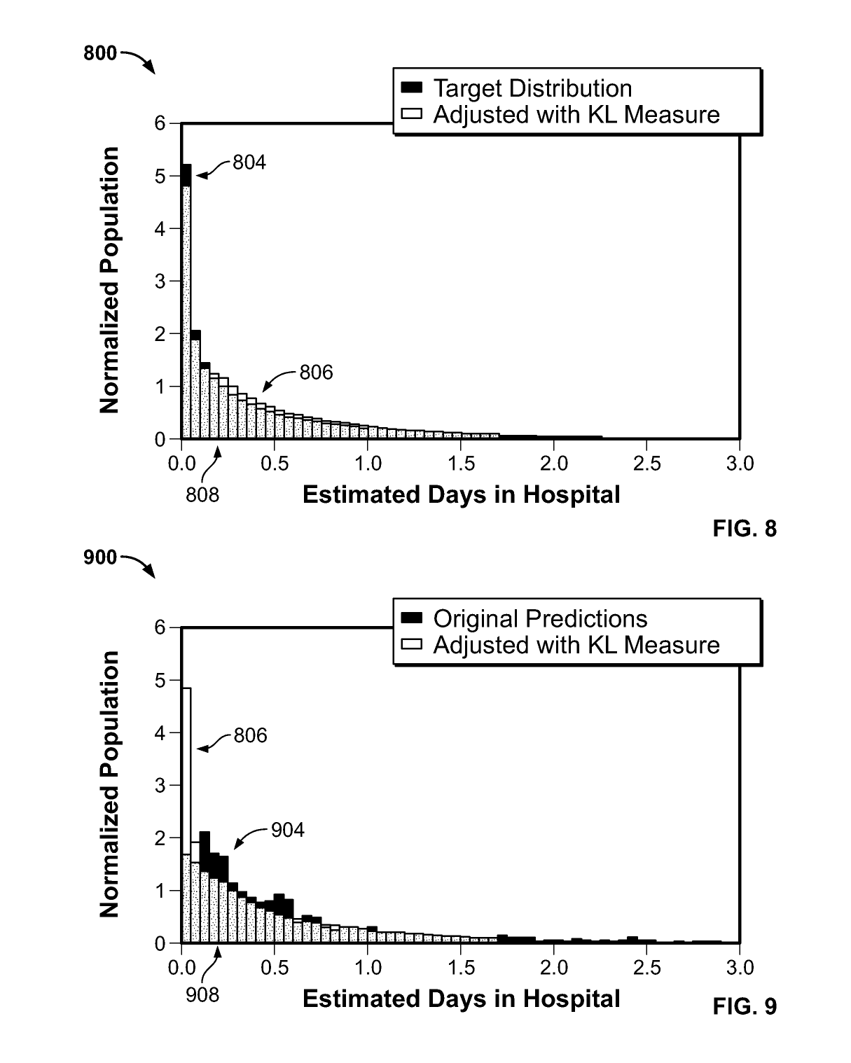

FIGS. 8-11 are graphs comparing the histogram of the modified observations with the histogram of the original observations and the target histogram. FIGS. 8 and 9 show a comparison between the modified observation against the target distribution, as well as the histogram of the original observations using the KL formulation with the dissimilarity parameter σ=0.0001.

Referring to FIG. 8, a graph 800 shows a target histogram 804, an adjusted historgram 806 based on a modification of the original observations, and an overlap 808 between the distributions 804 and 806. The KL divergence between the target histogram 804 and the adjusted histogram 806 for the KL formulation with the dissimilarity parameter σ=0.0001 is 0.00617. This discrepancy comes from the fact that the KL divergence is estimated using linear functions.

FIG. 9 shows a graph 900 including the original histogram 904, the adjusted historgram 806 based on a modification of the original observations using the KL formulation, and an overlap 908 between the distributions 904 and 806. As shown by FIG. 9, the data elements of the original distribution 904 are modified to increase the quantity of data elements associated with the bin corresponding to 0 to 0.01 days in the hospital so that the adjusted histogram 806 more closely resembles the target histogram 804 shown in FIG. 8.

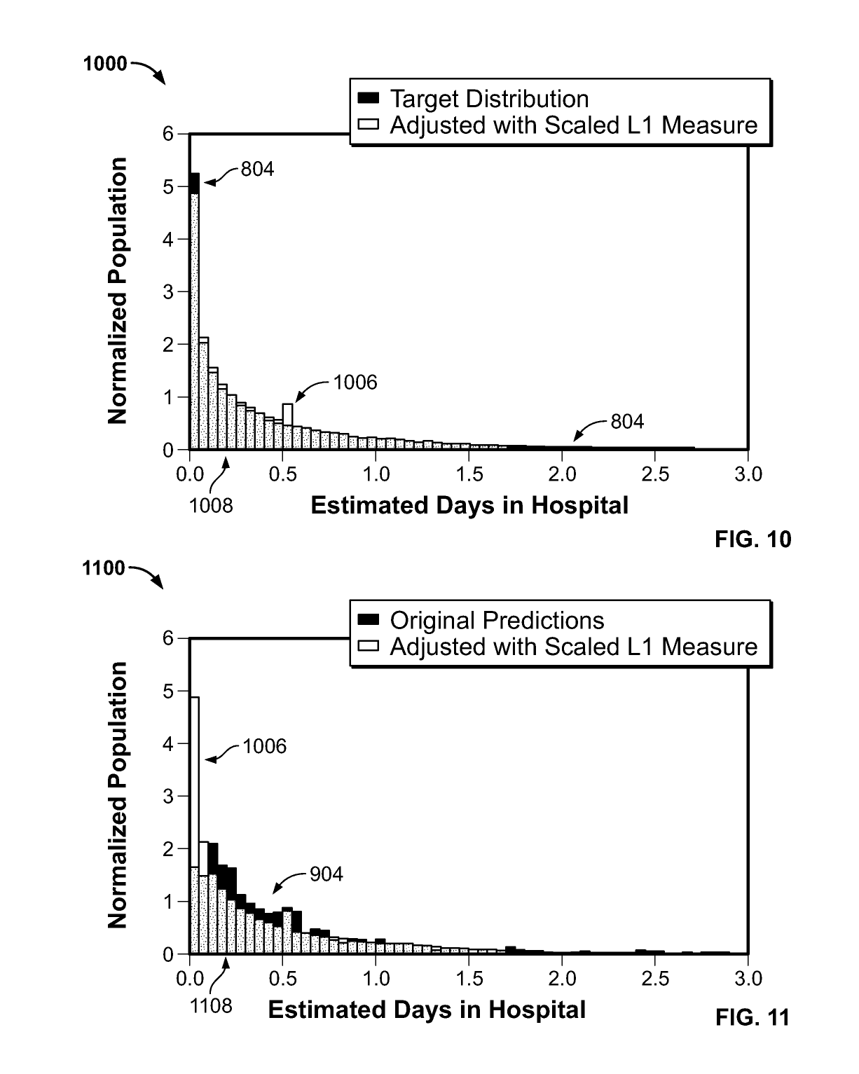

FIGS. 10 and 11 show a comparison between the modified observation against the target distribution as well as the histogram of the original observations using scaled L1 formulations. Referring to FIG. 10, a graph 1000 shows the target histogram 804, an adjusted historgram 1006 based on a modification of the original observations using a scaled L1 measure, and an overlap 1008 between the distributions 804 and 1006. As shown by FIG. 11, the data elements of the original distribution 904 are modified to increase the quantity of data elements associated with the bin corresponding to 0 to 0.01 days in the hospital so that the adjusted histogram 1006 more closely resembles the target histogram 804 shown in FIG. 10.

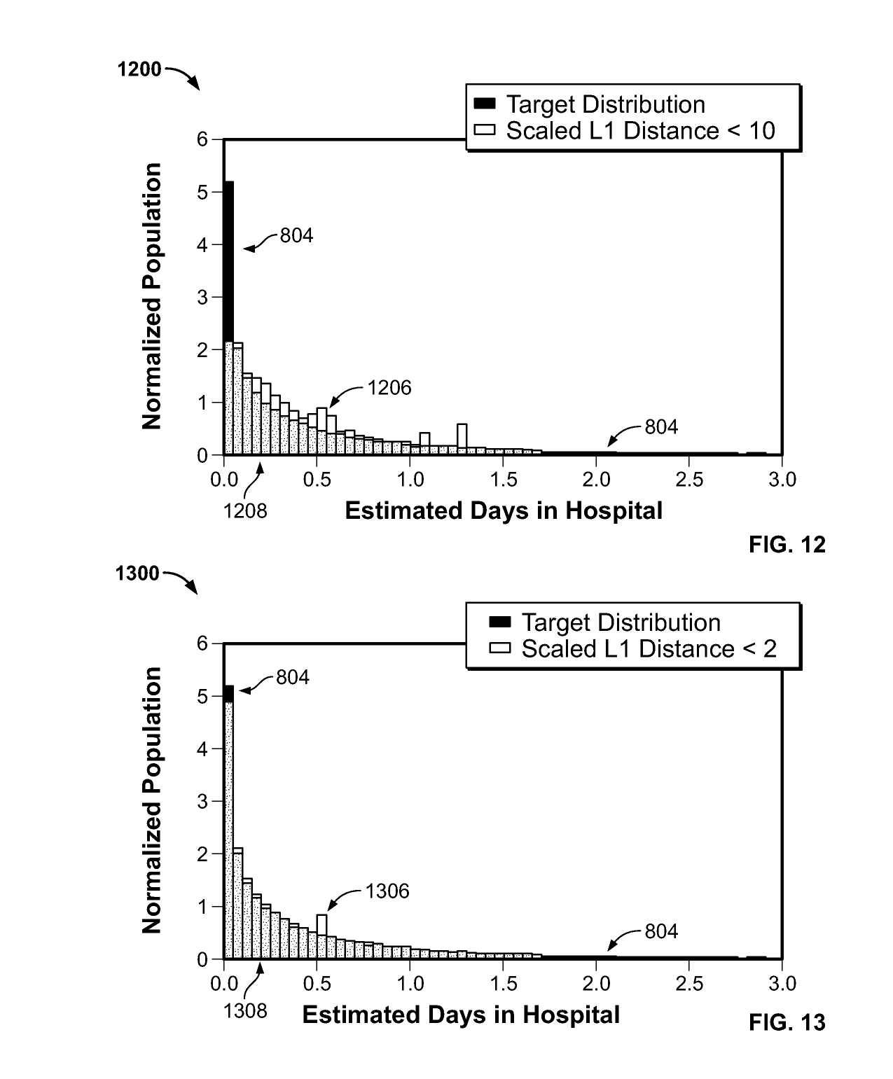

FIGS. 12 and 13 show graphs 1200 and 1300 which compare using different boundaries for the scaled L1 distance. The graph 1200 of FIG. 12 shows the target histogram 804, an adjusted historgram 1206 based on a modification of the original observations using a scaled L1 distance of less than ten (10), and an overlap 1208 between the distributions 804 and 1206. The graph 1300 of FIG. 13 shows the target histogram 804, an adjusted historgram 1306 based on a modification of the original observations using a scaled L1 distance of less than two (2), and an overlap 1308 between the distributions 804 and 1306. As shown by the graphs 1200 and 1300, the lower range of scaled L1 distances produces a modified histogram that more closely resembles the target histrogram.

Experiments were also performed with respect to predicting the probability of default for clients of a financial institution. In these experiments, is it important to find the correct rank-ordering of the clients as well as to make an accurate prediction of the probability of default. This probability can be used to make decisions such as whether or not a client is granted a specific line of credit, or it might be used to estimate expected revenue. In these experiments, exemplary embodiments of the histogram adjustment process can be used to post-process the probability of default assigned to each client based on an existing predictive model, and to improve the performance of the model by adjusting the probability estimates. A training set of about 1.4 million clients is provided and a validation set of around 350,000 clients is provided. For each element of these sets a binary label indicating whether or not the client has defaulted is provided and the probability of default assigned by the model to that client is provided.

To get a target distribution for histogram adjustment, the binary values are transformed into probabilities. To achieve this, the training set is sorted based on the estimated probability assigned by the model, and the elements of the training set are bundled into groups of size 500. The probability of default for each bundle, as a result, is the ratio of elements with label 1 (indicating default) and these values are referred to herein as target probabilities. The histogram of the target probabilities is the target distribution. Also, for each bundle, the average of the probabilities of default predicted by the model is used as the original prediction of probability for that bundle. The same procedure is used to generate bundles from the validation set, as well.

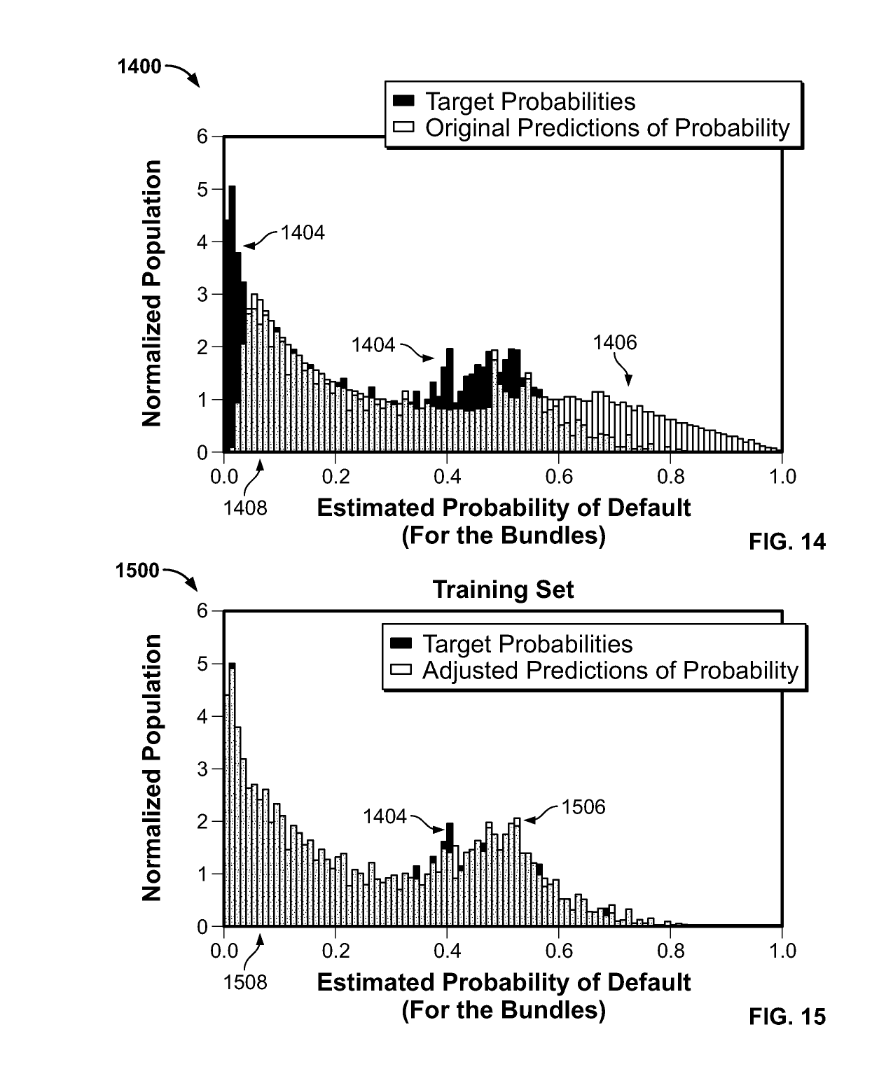

FIG. 14 shows a graph 1400 that includes a target distribution 1404, an original distribution 1406 that was generated based on prediction associated with the probabilities that clients will default, and an overlap 1408 between the distributions 1404 and 1406. As shown in FIG. 14, the original distribution 1406 includes more data elements in the bins associated with a higher probability of default than the target distribution 1404.

An exemplary embodiment of the distribution adjustment process is applied on the training set to adjust the values of the original prediction of probabilities based on the histogram of target probabilities. As a result, for each original probability value corresponding to a bundle, an adjusted value set equal to the center of the bin to which it is assigned is obtained. Using linear interpolation over the original/adjusted value pairs, a piecewise-linear calibration function is obtained that can map any new value to an adjusted value. A prediction of the probability of default that the original model makes for any new individual client can be processed by this piecewise-linear calibration function to obtain an adjusted probability.

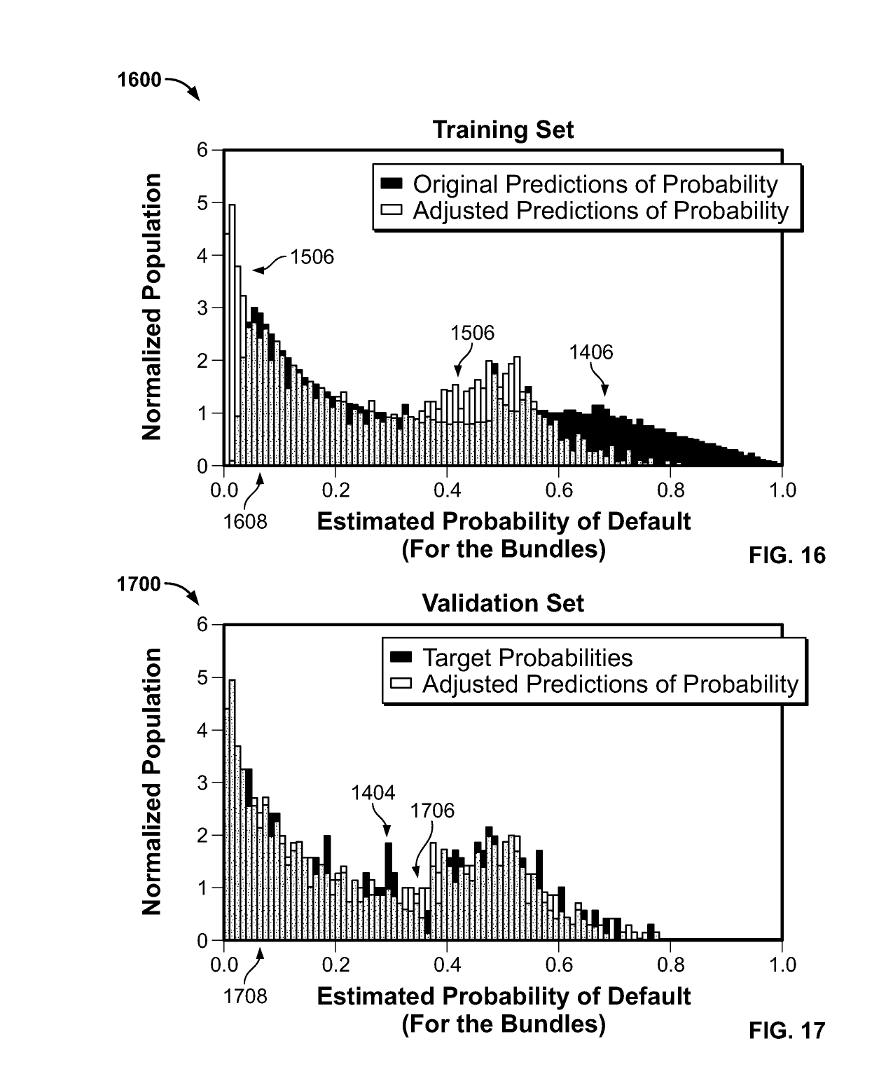

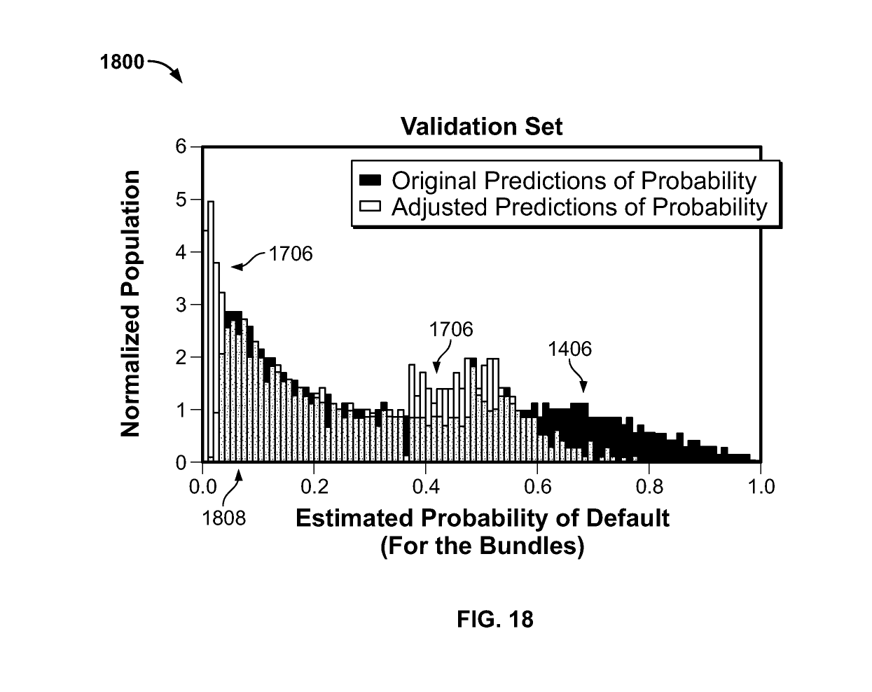

In order to examine the performance of the model before and after histogram adjustment, for each bundle from the validation set, this piecewise-linear calibration function is used to adjust the original prediction of probability for that bundle. The adjusted histograms of the training and the validation sets as well as the corresponding target histograms are shown in FIGS. 15-18. FIG. 15 shows a graph 1500 illustrates a comparison between the target distribution 1404 and the adjusted distribution 1506 for the training set of data and FIG. 16 shows a graph 1600 illustrates a comparison between the original distribution 1406 and the adjusted distribution 1506 for the training set of data. FIG. 17 shows a graph 1700 illustrates a comparison between the target distribution 1404 and the adjusted distribution 1706 for the validation set of data and FIG. 18 shows a graph 1800 illustrates a comparison between the original distribution 1406 and the adjusted distribution 1706 for the training set of data.

As the measure of performance, the mean squared error (MSE) of the predicted probabilities assigned to the bundles is used with respect to their target probabilities. MSE is used instead of area under the curve (AUC) or the Kolmogorov-Smirnov (KS) test. Since the histogram adjustment process preserves the rank ordering, AUC and KS are not be affected by the histogram adjustment process. Table 4 shows the MSE values for different values of the dissimilarity parameter σ. As shown in Table 3, by reducing the dissimilarity parameter σ, the value of MSE first reduces and then increases. This means that after some point, trying to decrease the dissimilarity of the histograms results in increasing the validation error.

TABLE 3
Mean squared error of the original predictions and histogram adjusted
predictions for different values of the dissimilarity parameter σ.

| | MSE - Training | MSE - Test |
|---|---|---|
| Original Predictions | 0.01556 | 0.01577 |
| Histogram Adjusted (σ = 1.0) | 0.0008847 | 0.0007211 |
| Histogram Adjusted (σ = 0.1) | 0.0008307 | 0.0007211 |
| Histogram Adjusted (σ = 0.001) | 0.0008276 | 0.0007288 |

Exemplary embodiments are described herein to implement a distribution adjustment process using a mixed-integer programming (MIP) framework that achieves a trade-off between the extent to which initial data elements of a vector are modified and the dissimilarity between a distribution of the data elements and a target or reference distribution. Additionally, exemplary embodiments of the present disclosure can implemented as mixed-integer linear programs (MILP) and can be efficiently solved with satisfactory accuracy for reasonable problem sizes (e.g., a few thousand data elements and few hundred bins). For larger problems, grouping of observation points can be used to make the problem size manageable.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention.

What is claimed is:

1. A computer-implemented method of adjusting a distribution of data elements, the method comprising:
assigning a modification constraint to limit a modification of data elements in a subject distribution;
identifying a reference distribution; and
executing code to modify at least one of the data elements in the subject distribution to generate a modified distribution based on a reference distribution, a modification of the at least one of the data elements being constrained in response to the modification constraint.

2. The computer-implemented method of claim 1, wherein the modification constraint is a maximum offset that can be applied to the data elements.

3. The computer-implemented method of claim 1, wherein the modification constraint is a maximum dissimilarity between the modified distribution and the reference distribution.

4. The computer-implemented method of claim 1, wherein executing code to modify at least one of the data elements comprises solving a mixed-integer linear program to minimize an offset applied to the at least one data element and minimize a dissimilarity between the subject distribution and the reference distribution.

5. The computer-implemented method of claim 1, wherein the modified distribution is a histogram having bins to which the data elements are assigned.

6. The computer-implemented method of claim 5, wherein the modification constraint prohibits assigning the data elements to more than one of the bins subsequent to modification of the data elements.

7. The computer-implemented method of claim 6, wherein modifying at least one of the data elements comprises applying an offset to the at least one of the data elements to modify a data value of the at least one of the data elements to be a center value of one of the bins

8. The computer-implemented method of claim 7, wherein the offset is applied to modify the data value of the at least one of the data elements so that the data element remains in an originally assigned bin.

9. The computer-implemented method of claim 7, wherein the offset is applied to modify the data value of the at least one of the data elements so that the data value corresponds to the center value of a different bin than an original bin to which the data element was assigned.

10. The computer-implemented method of claim 5, wherein modifying at least one of the data elements comprises applying an offset to the at least one of the data elements, wherein the offset is a convex combination of two consecutive bin edges.

11. The computer-implemented method of claim 5, wherein the modification constraint is a dissimilarity measure between the modified distribution and the reference distribution.

12. The computer-implemented method of claim 11, wherein the dissimilarity measure is defined on a bin-by-bin basis by comparing corresponding pairs of bins of the subject distribution and the reference distribution.

13. The computer-implemented method of claim 11, wherein the dissimilarity measure is determined utilizing a Minkowski distance giving by:
$${( {\sum }_{j} {\vert {p}_{j} - {q}_{j} \vert}^{t} )}^{1 / t}$$
where j denotes a bin index, pⱼ denotes a population of a bin bⱼ in the reference histogram, qⱼ denotes a quantity of data elements of the subject distribution that fall into the bin bⱼ, and t denotes an order of the Minkowski distance.

14. The computer-implemented method of claim 11, wherein the dissimilarity measure is determined utilizing a scaled distance measure given by:
$${( {\sum }_{j} {\vert {w}_{j} ( {p}_{j} - {q}_{j} ) \vert}^{t} )}^{1 / t}$$
where j denotes a bin index, denotes a population of a bin bⱼ in the reference histogram, qⱼ denotes a quantity of data elements of the subject distribution that fall into the bin bⱼ, t denotes an order of the scaled distance measure, and w denotes a weighting factor.

15. The computer-implemented method of claim 11, wherein the dissimilarity measure is determined utilizing a Kullback-Leibler Divergence dissimilarity measure given by:
$${\sum }_{j = 1}^{m} {p}_{j} log \frac{{p}_{j}}{{q}_{j}}$$
where j denotes a bin index, denotes a population of a bin bⱼ in the reference histogram, qⱼ denotes a quantity of data elements of the subject distribution that fall into the bin bⱼ.

16. A non-transitory computer-readable medium storing instruction executable by a processing device, wherein execution of the instructions by the processing device implements a computer-implemented method of adjusting a distribution of data elements comprising:
assigning a modification constraint to limit a modification of data elements in a subject distribution;
identifying a reference distribution; and
executing code to modify at least one of the data elements in the subject distribution to generate a modified distribution based on a reference distribution, a modification of the at least one of the data elements being constrained in response to the modification constraint.

17. The computer-readable medium of claim 16, wherein the modification constraint is a maximum offset that can be applied to the data elements.

18. The computer-readable medium of claim 16, wherein the modification constraint is a maximum dissimilarity between the modified distribution and the reference distribution.

19. The computer-readable medium of claim 16, wherein the modified distribution is a histogram having bins to which the data elements are assigned.

20. The computer-readable medium of claim 19, wherein the modification constraint prohibits assigning the data elements to more than one of the bins subsequent to modification of the data elements.

21. The computer-readable medium of claim 20, wherein modifying at least one of the data elements comprises applying an offset to the at least one of the data elements to modify a data value of the at least one of the data elements to be a center value of one of the bins

22. The computer-readable medium of claim 19, wherein the modification constraint is a dissimilarity measure between the modified distribution and the reference distribution.

23. The computer-readable medium of claim 11, wherein the dissimilarity measure is defined on a bin-by-bin basis by comparing corresponding pairs of bins of the subject distribution and the reference distribution.

24. A system for adjusting a distribution of data elements comprising:
a non-transitory computer-readable medium storing executable code for implementing an adjustment of a distribution; and
a processing device programmed to execute the code to:
assign a modification constraint to limit a modification of data elements in a subject distribution;
identify a reference distribution; and
modify at least one of the data elements in the subject distribution to generate a modified distribution based on a reference distribution, a modification of the at least one of the data elements being constrained in response to the modification constraint.

25. The system of claim 24, wherein the modification constraint is a maximum offset that can be applied to the data elements.

26. The system of claim 24, wherein the modification constraint is a maximum dissimilarity between the modified distribution and the reference distribution.

27. The system of claim 24, wherein the modified distribution is a histogram having bins to which the data elements are assigned.

28. The system of claim 27, wherein the modification constraint prohibits assigning the data elements to more than one of the bins subsequent to modification of the data elements.

29. The system of claim 28, wherein modifying at least one of the data elements comprises applying an offset to the at least one of the data elements to modify a data value of the at least one of the data elements to be a center value of one of the bins

30. The system of claim 27, wherein the modification constraint is a dissimilarity measure between the modified distribution and the reference distribution.

31. The system of claim 30, wherein the dissimilarity measure is defined on a bin-by-bin basis by comparing corresponding pairs of bins of the subject distribution and the reference distribution.
